(19) United States
(12) Patent Application Publication
(10) Pub. No.: US 2012/0145020 A1
(43) Pub. Date: Jun. 14, 2012

(54) DEVICE FOR REGULATING THE APPLICATION OF DAMPENING SOLUTION AND INK IN A PRINTING PRESS

(75) Inventors: Peter Knauer, Muenster/Lech (DE); Karl Altthaler, Augsburg (DE); Stefan Wasserbaech, Olching (DE)

(73) Assignee: manroland AG, Offenbach/Main (DE)

(21) Appl. No.: 13/209,266

(22) Filed: Aug. 12, 2011

(30) Foreign Application Priority Data
Aug. 14, 2010 (DE) 10 2010 034 350.1

(51) Int. Cl. B41L 25/00

(52) U.S. Cl. 101/148

(57) ABSTRACT

A device for regulating the application of dampening solution in a printing press is disclosed. The device includes a dampening solution quantity adjustment apparatus, where a quantity of dampening solution applyable to a printing press cylinder is adjustable by the dampening solution quantity adjustment apparatus. An ink measuring device detects printing parameters of an ink applied to a printing substrate selectively and/or over an entire width of the printing substrate. A control and regulating device analyzes detected printing parameters and controls the dampening solution quantity adjustment apparatus.

This application claims the priority of German Patent Document No. 10 2010 034 350.1, filed Aug. 14, 2010, the disclosure of which is expressly incorporated by reference herein.

### BACKGROUND AND SUMMARY OF THE INVENTION

The invention relates to a device for regulating the application of dampening solution and if applicable the application of ink in a printing press.

Wetting the non-printing locations on a printing plate with dampening solution and wetting the printing locations with ink is generally known in the case of lithographic printing methods. Metering the dampening solution is controlled via the central control console. In the case of film dampening units, the rotational speed of the dampening distribution roller is triggered and the quantity of dampening solution is controlled manually via the web width through changes in compression between the dipping roller and the dampening distribution roller. In the case of nozzles and centrifugal dampening units, the quantity of dampening solution is controlled via the spraying frequency of the nozzles or via the jaw opening in the case of turbo dampening systems.

The disadvantage of the controlled metering of the quantity of dampening solution is that maladjustments may also occur.

A dampening unit for a printing press is known from German Patent Document DE 10 2004 022 084 A1, which has means for applying a dampening solution to a printing plate and means for adjusting the quantity of dampening solution, wherein a sensor is provided for detecting the quantity of dampening solution applied to a printing plate. In this case, the sensor detects the layer thickness of the dampening solution on the printing plate. The quantity of dampening solution on the printing plate is controlled via a comparison with a predetermined quantity of dampening solution. Thus, this regulation of the quantity of dampening solution is carried out on the basis of sensor measuring data with respect to the layer thickness of the dampening solution.

The object of the invention is improving the regulation of the application of dampening solution and if applicable also the application of ink in a printing press, in particular in a printing couple.

According to a first subject of the invention, a device for regulating the application of dampening solution in a printing press having means for applying a dampening solution on an impression cylinder and means for adjusting the quantity of dampening solution is provided, wherein:
at least one ink measuring device is provided for detecting the printing parameters of the ink applied to the printing substrate, wherein the detection of the printing parameters is carried out selectively and/or over the entire width of the printing substrate;
a control and regulating device is provided for analyzing printing parameters of the applied ink determined selectively and/or over the entire width of the printing substrate; and
the means for adjusting the quantity of dampening solution on the impression cylinder are controllable as a function of the determined printing parameters of the applied ink.

Another subject of the present invention relates to a device for regulating the application of dampening solution in a printing press having means for applying a dampening solution on an impression cylinder and means for adjusting the quantity of dampening solution, wherein:
at least one ink measuring device is provided for detecting printing parameters of the ink applied to the printing substrate, wherein the detection of the printing parameters is carried out selectively and/or over the entire width of the printing substrate;
a control and regulating device is provided for analyzing printing parameters of the applied ink determined selectively and/or over the entire width of the printing substrate;
the control and regulating device is designed for determining a time progression of the determined printing parameters of the applied ink; and
the means for adjusting the quantity of dampening solution on the impression cylinder are controllable as a function of instabilities in the time progression of the determined printing parameters of the applied ink.

One difference of the subjects of the invention from the above-mentioned prior art in this case is that it is not necessary for sensor-based detection of the layer thickness of the dampening solution on the printing plate to be carried out. In contrast, the optically detectable printing parameters of the ink applied to the printing substrate, which ultimately bring about the optical impression of the printed ink and thus the result of the printing process, is detected selectively and/or over the entire width of the printing substrate. Detection may take place at any printed location of the printing substrate, for example in areas in which measuring strips are printed or in areas in which subjects, i.e., printed images of any type, are printed in the form of images and/or text. Thus, the ink measuring device is designed in such a way that it detects optically detectable parameters or conditions of the ink applied to the printing substrate, wherein the full-tone density and/or the tonal value increase serve as an indicator or the basis of regulation for required control and regulating processes.

Selective detection means a detection in particular only in the direct optical detection area of the ink measuring device, i.e., insofar as this does not extend over the entire width of the printing substrate, this means an area in the direction of the width of the printing substrate, which has a smaller expansion than the width of the printing substrate. Thus, a results-oriented device is made available. The printing substrate may be configured as a web-like printing substrate, for example as a paper web or paper roll or even as a sheet-like printing substrate, for example as a paper sheet or cardboard sheet.

Furthermore, it was recognized in the course of the invention that instabilities in the time progression of the determined printing parameters of the applied ink such as time fluctuations in the determined printing parameters of the applied ink permit conclusions to be drawn about the quantity of dampening solution and about the necessity for adapting the quantity of dampening solution and therefore can be used as an input quantity for regulating the quantity of dampening solution on the impression cylinder. In particular, in this case periodic fluctuations of printing parameters are used, which are determined by the ink measuring device and which are used by the control and regulating device as the basis for regulating the controlled values. In particular, the amplitude and/or the frequency of these types of periodic fluctuations may be used for the magnitude of regulating the controlled values so that the amplitude and/or the frequency of such periodic fluctuations may be included as an input quantity in a change specification for the controlled values. At the same time, volatile changes in the printing parameters may be used, which are determined by the ink measuring device and which are used by the control and regulating device as the basis for regulating the controlled values. In particular, in this case the intensity (i.e., the amount of change in a printing parameter) of such volatile changes can be used for the magnitude of regulating the controlled values so that the intensity (i.e., the amount of the change in a printing parameter) can be included as an additional or alternative input quantity in a change specification for the controlled values.

The detected printing parameters within the scope of the invention are those parameters that characterize the ink(s) printed on the printing substrate, particularly parameters that characterize the ink density and/or the ink consistency and/or the ink contrast and/or the ink dot size of ink halftone dots and/or the shape of ink halftone dots and/or the relative arrangement of ink halftone dots to each other respectively for the ink(s) applied to the printing substrate.

In this case, it may be provided in particular that the ink measuring device is designed for detecting the full-tone density and/or the tonal value increase of the ink, which is applied to the printing substrate. The ink measuring device may detect optically detectable parameters or conditions of the ink applied to the printing substrate, wherein the full-tone density and/or the tonal value increase serve as an indicator or the basis of regulation for required control and regulating processes.

The ink measuring device may be designed in particular for detecting printing parameters of the applied ink in printed measuring strips and/or for detecting printing parameters of the applied ink in printed subjects. In the case of detecting printing parameters in measuring strips, separate measuring strips are detected from the actual printed image or the printed area of the finished printed copy, which are applied especially for the purpose of detecting printing parameters on the printing substrate. In the case of detecting the printing parameters in printed subjects, printing parameters are detected directly in the actual printed image or printed area of the finished printed copy (also known as “measurement in the image”).

Several ink measuring devices may be provided, which are arranged in a distributed manner over the width of the printing substrate. Thus, an entire measuring area can be detected simultaneously, which includes the entire width of the printing substrate.

The ink measuring device or the several ink measuring devices may be designed as an optical ink measuring device in the form of a camera or a spectrometric device.

In addition, the control and regulating device may be designed for comparing the actual values of the printing parameters of the applied ink determined selectively and/or over the entire width of the printing substrate with predetermined and/or pre-stored target values for the printing parameters of the applied ink determined selectively and/or over the entire width of the printing substrate, wherein means are provided for adjusting the ink quantity on the impression cylinder, wherein in addition the means for adjusting the ink quantity on the impression cylinder are controllable as a function of deviations of the actual values of the printing parameters of the applied ink determined selectively and/or over the entire width of the printing substrate from the predetermined and/or pre-stored target values for the printing parameters of the applied ink determined selectively and/or over the entire width of the printing substrate. As a result, in addition to regulating the application of dampening solution, it is also possible to regulate the application of ink.

A device according to the invention may have for example a film dampening unit having at least one dipping roller and one dampening distribution roller, wherein to adjust the quantity of dampening solution:
the compression of the dipping roller against the dampening distribution roller; and/or
the angular adjustment of the dipping roller with respect to the dampening distribution roller; and/or
the speed of the dampening distribution roller and/or the dipping roller are adjusted.

However, a device according to the invention may also have for example a centrifugal dampening unit having at least one dampening distribution roller and one dampening form roller, wherein to adjust the quantity of dampening solution:
adjustable shutters can be triggered; and/or
the rotational speed of the dampening distribution roller and/or the rotational speed of the dampening form roller are controllable.

However, a device according to the invention may also have a spray dampening unit having at least one dampening distribution roller and one dampening form roller, wherein to adjust the quantity of dampening solution:
the spraying frequency and/or the spraying duration are controllable; and/or
the rotational speed of the dampening distribution roller and/or the rotational speed of the dampening formed roller are controllable.

The control and regulating device may be designed as a self-learning control and regulating device, wherein the settings of the controlled values can be saved in the control and regulating device (3) and can be retrieved as preset data. For this purpose, self-learning algorithms are stored in the control and regulating device, which stores controlled values over several print jobs in a data memory of the control and regulating device, in particular as a function of and linked to data related to the ink used in the print job and/or ink composition and/or type of printing substrate and/or duration of the print job and/or temperature or temperature progression of individual devices of the printing press or the printing couple. In the case of a subsequent print job, these controlled values may be retrieved from the data memory and made available to the control and regulating device as preset data. When starting a new print job, the optimal settings may thus be stored and retrieved for the control and regulating device of the dampening unit as preset data for the next job of this type.

In addition, the control and regulating device is advantageously designed in this respect as self-learning and automatically balances out changes in the roller coatings as a result of swelling or shrinkage.

The ink measuring devices may be designed for detecting printing parameters only on one side of the printing substrate, i.e., be arranged in particular only on one side of the printing substrate, but they may also be designed for detecting printing parameters on both sides of the printing substrate, i.e., be arranged in particular on both sides of the printing substrate. The control and regulating device is then designed accordingly for analyzing the printing parameters on one side and/or on both sides of the printing substrate.

In addition, it is possible to dispense with the arduous determination of a so-called “dampening acceleration curve” for different materials, because the rotational speed of the dampening unit just like the print widths of the dipping roller may be regulated via a control signal of the device according to the invention.

In addition, a device according to the invention is able to identify smudging, scumming and ink degradation in good time and thereby reduce waste in an advantageous manner.

Additional features and advantages of the invention are disclosed in the drawings in conjunction with the following description. The invention will be explained in greater detail in the following on the basis of the associated schematic drawings.

### BRIEF DESCRIPTION OF THE DRAWINGS

FIG. 1 illustrates a device according to the invention with a film dampening unit;

FIG. 2 illustrates adjusting devices of a film dampening unit according to the invention;

FIG. 3 illustrates a device according to the invention with a spray dampening unit;

FIG. 4 illustrates a device according to the invention with a centrifugal dampening unit;

FIG. 5 illustrates an ink duct roller and ink zone meter for adjusting the ink quantity;

FIG. 6 illustrates a printed area on a printing substrate;

FIG. 7 illustrates an ink zone of FIG. 6; and

FIG. 8 illustrates an embodiment of a printing couple incorporating the principles of the present invention.

### DETAILED DESCRIPTION OF THE DRAWINGS

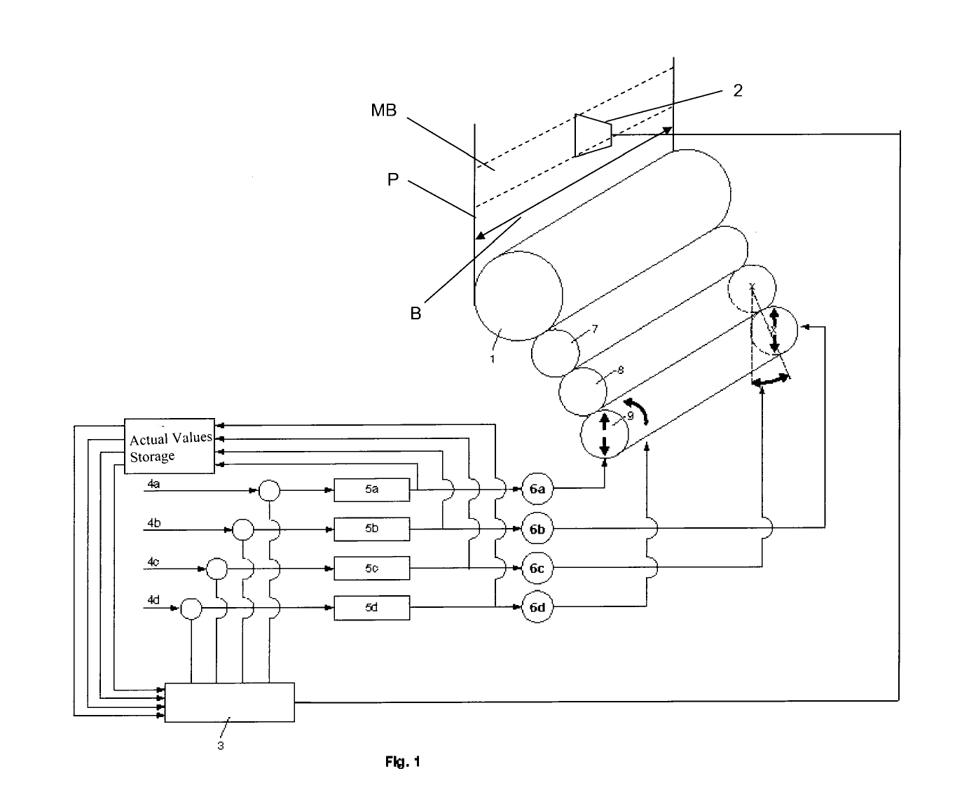

FIG. 1 schematically depicts the principle according to the invention on the basis of a film dampening unit. An impression cylinder 1 is depicted as a section of a printing press, which normally cooperates with a transfer cylinder. Situated on the impression cylinder 1 is a printing plate (not depicted explicitly), which is provided with ink-absorbing and ink-repelling regions. If a dampening solution is applied to the impression cylinder 1, then it remains adhering to the ink-repelling regions of the printing plate.

At least one ink measuring device 2 is provided for detecting printing parameters of the ink applied to the printing substrate P, wherein the detection of the printing parameters is carried out selectively or over the entire width B of the printing substrate P in a measuring area MB. Selective detection means a detection in particular only in the direct optical detection area of the ink measuring device, i.e., insofar as this does not extend over the entire width of the printing substrate, this means an area in the direction of the width of the printing substrate, which has a smaller expansion than the width of the printing substrate. A control and regulating device 3 is provided for analyzing the printing parameters of the applied ink determined selectively and/or over the entire width B of the printing substrate P. The means for adjusting the quantity of dampening solution on the impression cylinder 1 are controllable as a function of a time progression of the determined printing parameters of the applied ink.

Instead of a single ink measuring device 2, several ink measuring devices 2 may also be provided, which are arranged in a distributed manner over the width B of the printing substrate P. This allows for the possibility of simultaneously detecting a measuring area MB, which extends over the entire width B of the printing substrate P (for example of a paper web or a paper sheet), as well as for the possibility of simultaneously analyzing the different areas of the printing substrate B and, thus, it is possible to also regulate different areas of the means for applying a dampening solution in different ways, i.e., to regulate the application of dampening solution over the width B of the printing substrate in different ways.

Means for adjusting the quantity of dampening solution on the impression cylinder 1 will now be explained by way of example based on the figures:

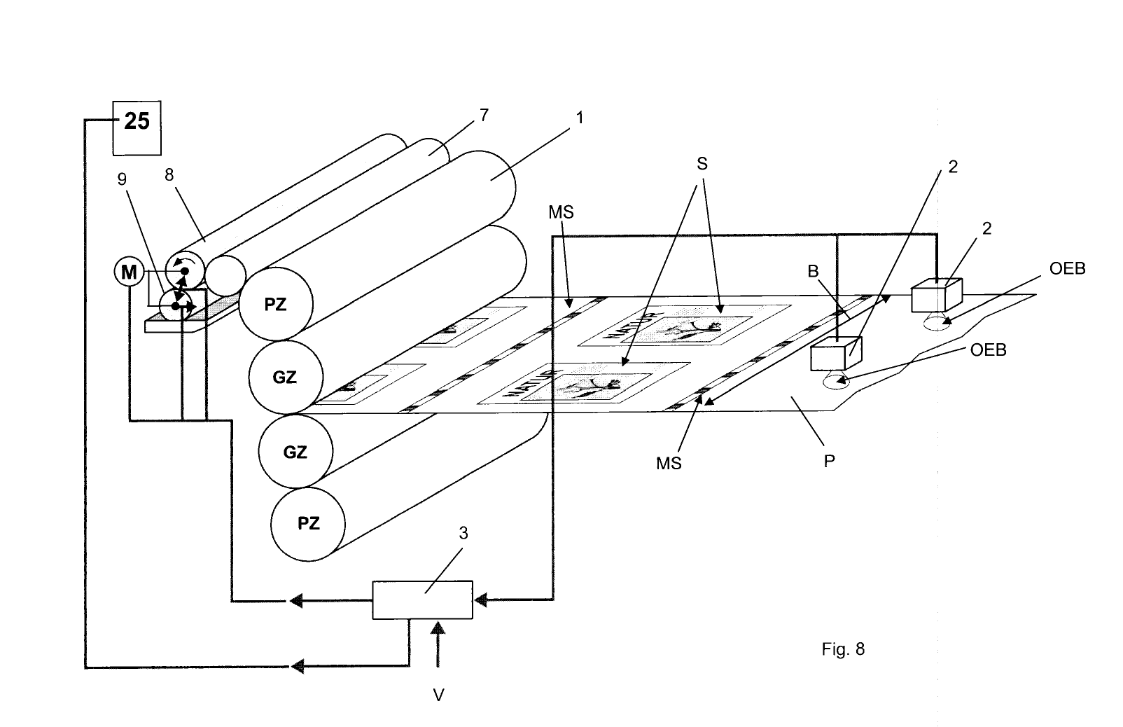

The quantity of dampening solution, which is applied to the impression cylinder, depends in particular on the compression between a dipping roller 9 and a dampening distribution roller 8 as well as on the angular adjustment of the dipping roller 9 with respect to the dampening distribution roller 8 and on the dampening distribution roller speed, i.e., on the rotational speed of the dampening distribution roller 8 and/or the rotational speed of the dipping roller 9. Preset values 4 may be predetermined as target values for these settings of compression, angular adjustment and rotation speed, i.e., default values 4a, 4b as target values for the compression between the dipping roller 9 and dampening distribution roller 8, default value 4c as the target value for the angular adjustment of the dipping roller 9 with respect to the dampening distribution roller 8 and default value 4d as the target value for the dampening distribution roller rotational speed or dipping roller rotational speed. This is shown schematically in FIG. 1 for the rotational speed of the dipping roller 9, and in FIG. 8 also for the rotational speed of the dampening distribution roller 8 and/or the dipping roller 9.

The control and regulating device 3 analyzes the printing parameters for the ink(s) applied to the printing substrate P from the signal of the ink measuring device 2. In the process, the actual values of the printing parameters for the ink(s) applied to the printing substrate P will be compared in particular with the target values for the printing parameters for the ink(s) applied to the printing substrate P, and, in addition, in particular an analysis of the time progression of the printing parameters for the ink(s) applied to the printing substrate P will be carried out. In doing so, the control and regulating device 3 determines in particular whether instabilities in the time progression of the determined printing parameters of the applied ink occur, in particular time fluctuations of the printing parameters of the applied ink. From the printing parameters of the applied ink, in particular from the instabilities or fluctuations in the time progression of the determined printing parameters, the control and regulating device 3 determines via an algorithm a change specification for the change of the target value of the compression between the dipping roller 9 and the dampening distribution roller 8 and/or for the change in the target value of the angular adjustment of the dipping roller 9 and/or for the change in the target value of the dampening distribution roller rotational speed or the dipping roller rotational speed with the objective of adjusting the actual values in accordance with the change specification. The changes in the printing parameters for the ink(s) applied to the printing substrate P are observed and detected via the ink measuring device 2 and, after making a comparison between target and actual values, the ascertained deviations are readjusted by corresponding regulating devices 5.

To adjust the compression between dipping roller 9 and the dampening distribution roller 8, two motors 6a, b are provided, which can adjust the roller mountings preferably via spindles. Another motor 6c is provided for the angular adjustment of the dipping roller 9 and a motor 6d is triggered for regulating the rotational speed of the dipping roller. Reaching the target values of the printing parameters is achieved when a so-called “good sheet” is produced. The good sheet has the desired printing quality and the adjusted values for the controlled values 4a, 4b, 4c and 4d may be saved and subsequently retrieved to the control and regulating device 3 for the production of a similar job. Every controlled value 4a, 4b, 4c, 4d by itself or in conjunction with one or several others may be regulated.

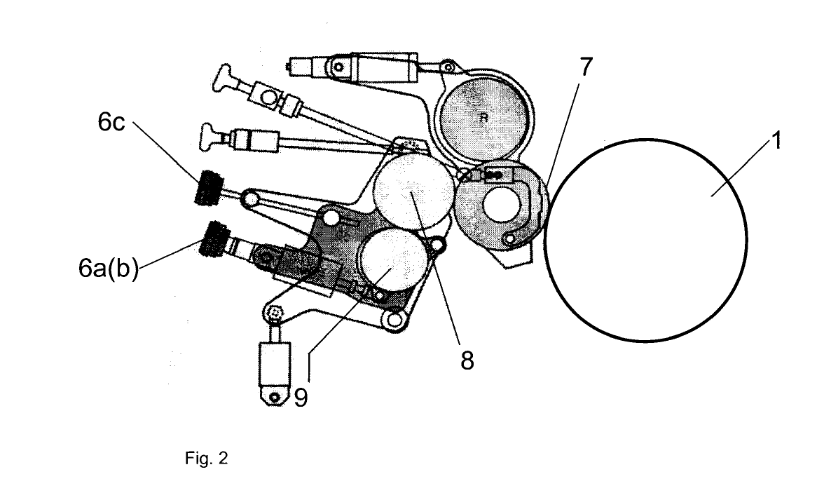

FIG. 2 depicts a side view of the adjustment possibilities of the film dampening unit. The dampener fountain roller 9 or the dipping roller 9 applies the dampening solution on a dampening distribution roller 8, which applies the dampening solution to the printing plate of the impression cylinder 1 via a form roller 7. To adjust the compression between the dipping roller 9 and the distribution roller 8, adjusting motors 6a, b are provided, which can adjust the position of the roller mounting preferably via spindles. An adjusting motor 6c is provided for angular adjustment of the dipping roller 9 with respect to the distribution roller 8, which likewise acts preferably via a spindle drive on the mounting of the fountain roller 9.

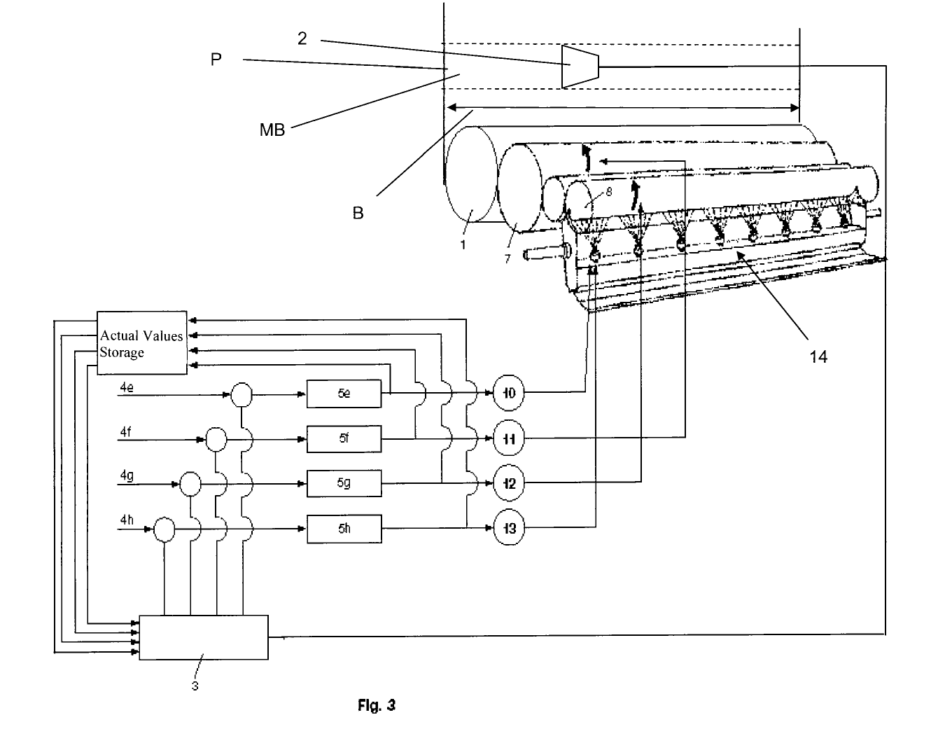

The principle according to the invention is shown in FIG. 3 on the basis of a spray dampening unit. In the case of a spray dampening unit, the dampening solution is sprayed via a spray bar 14 with several nozzles on a dampening distribution roller 8, which transfers the dampening solution via a dampening form roller 7 onto the impression cylinder 1. The quantity of dampening solution may be controlled via the cycle frequency 10 as well as the cycle duration 11 of spraying. In addition, the dampening distribution roller rotational speed 12 and the dampening form roller rotational speed 13 may also have an effect on the dampening solution layer thickness. As in the preceding exemplary embodiment, an ink measuring device 2 is also provided in this case, which relays the determined printing parameters for the ink(s) applied to the printing substrate P to a control and regulating device 3. The control and regulating device 3 analyzes the printing parameters for the ink(s) applied to the printing substrate P and determines via an algorithm a change specification for the change in the target value 10 of the cycle frequency and/or the target value 11 of the cycle duration and/or of the target value 12 of the dampening distribution roller rotational speed and/or the target value 13 of the rotational speed of the dampening form roller or the rotational speed of the dipping roller. After the determination of the modified target values, the corresponding deviations are readjusted. As soon as the first “good sheet” is produced, the ideal settings are reached, i.e., the current actual values 4e, 4f, 4g, 4h may serve as the new target values and therefore be saved as preset data for comparable print jobs. These values may then be retrieved for the next similar job to the control and regulating device 3 and be used as default values for the various settings.

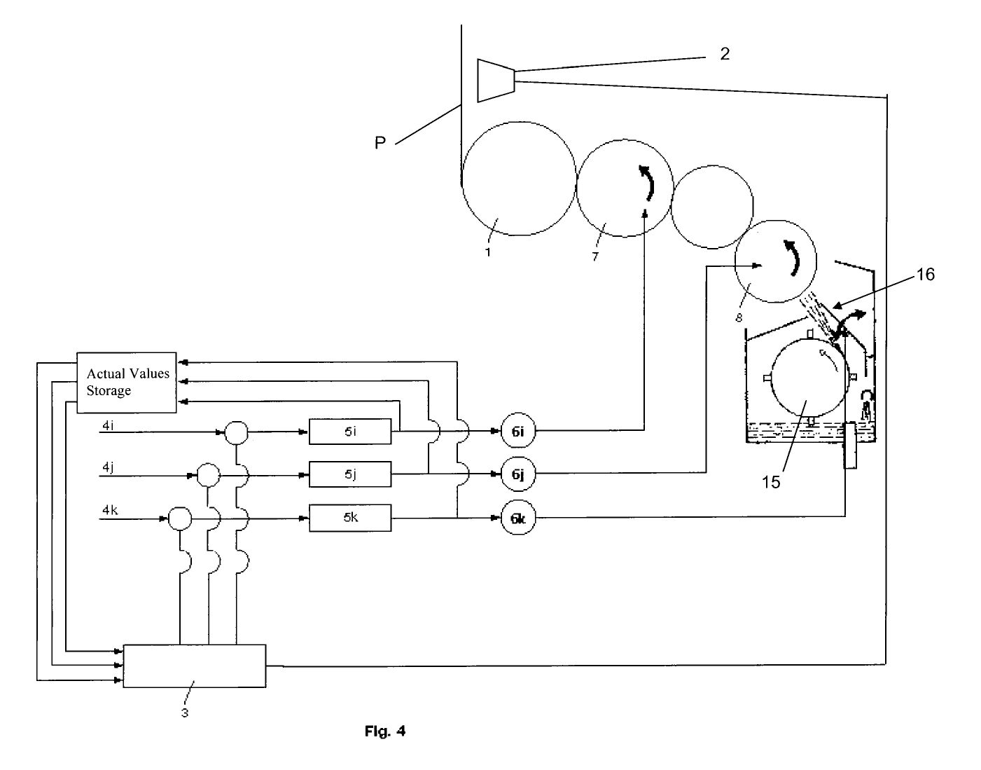

FIG. 4 depicts a centrifugal dampening unit according to the invention. In the case of centrifugal dampening units, the dampening solution is flung contactlessly via a rotor 15 onto a dampening distribution roller 8 or directly onto the impression cylinder 1. Adjustable shutters 16 are provided to meter the quantity of dampening solution. The dampening distribution roller rotational speed or the rotational speed of the dampening form roller 7 may also be used (i.e., regulated) for metering. As in the foregoing exemplary embodiments, an ink measuring device 2 is also provided in this case, which relays the determined printing parameters for the ink(s) applied to the printing substrate P to a control and regulating device 3. The control and regulating device 3 analyzes the printing parameters for the ink(s) applied to the printing substrate P and determines via an algorithm a change specification for the change in the actual value of the setting for the shutters 16 and/or the dampening distribution roller rotational speed and/or the dampening form roller rotational speed. Based on the determined modified actual values, the various settings for the shutters 16 and/or the dampening distribution roller rotational speed and/or the dampening form roller rotational speed may be readjusted by the regulators 5i, 5j, 5k. As soon as the first good sheet is produced, the optimal settings have been reached and the current actual values 4i, 4j, 4k may serve as the new target values and therefore be saved in a memory as preset data for comparable print jobs in order to be retrieved subsequently in a manner analogous to the foregoing exemplary embodiments.

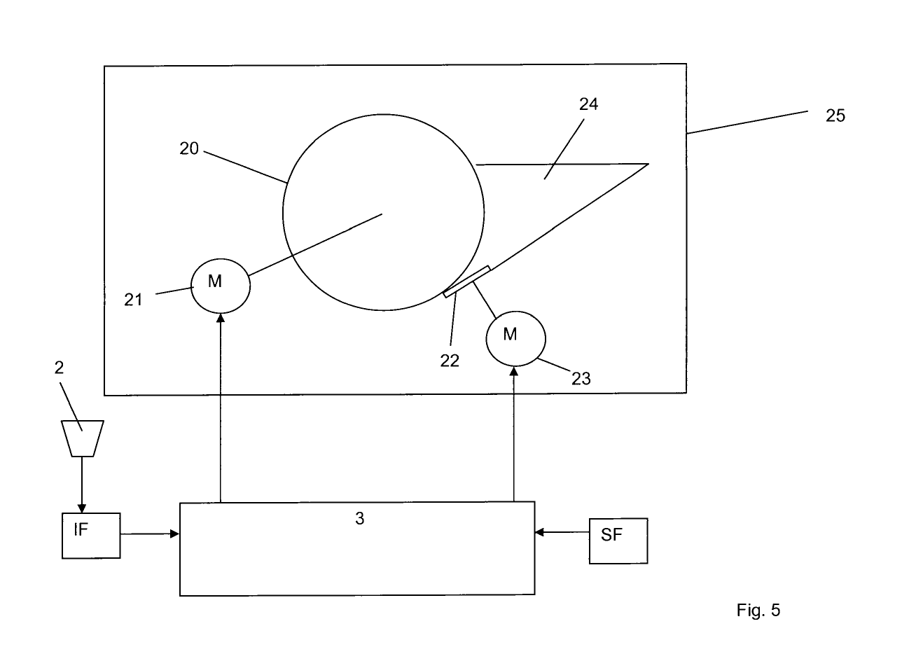

As FIG. 5 illustrates, the control and regulating device 3 is also designed for comparing:
the actual values IF of the printing parameters of the applied ink determined selectively and/or over the entire width B of the printing substrate P;
with
predetermined and/or pre-stored target values SF for the printing parameters of the applied ink determined selectively and/or over the entire width B of the printing substrate P.

FIG. 5 shows by way of example means 20, 21, 22, 23 for adjusting the ink quantity on an impression cylinder, however, other means 20, 21, 22, 23 can also be used within the scope of the invention for adjusting the ink quantity on an impression cylinder.

In this case, FIG. 5 schematically shows an inking couple 25 having an ink duct roller 20 with a motorized drive 21 with a variable rotational speed and exemplarily an ink zone meter 22 with a positioning motor 23 for the ink zone meter. These are used to adjust the ink quantity extracted from the ink fountain 24 and transferred onto an impression cylinder (not depicted explicitly in FIG. 5) by adjusting the rotational speed of the ink duct roller 20 and/or by adjusting the gap between the ink zone meter 22 and ink duct roller 20. In the process, a selective adjustment of the ink quantity limited to an ink zone is achieved by adjusting the gap between the ink zone meter 22 and the ink duct roller 20, whereas setting the ink quantity over the entire width B of the printing substrate P is accomplished by adjusting the rotational speed of the ink duct roller 20. The means 20, 21, 22, 23 for adjusting the ink quantity on the impression cylinder are controllable via the control and regulating device 3 as a function of deviations of the actual values IF of the printing parameters of the applied ink determined selectively and/or over the entire width B of the printing substrate P from the predetermined and/or pre-stored target values SF for the printing parameters of the applied ink determined selectively and/or over the entire width B of the printing substrate P.

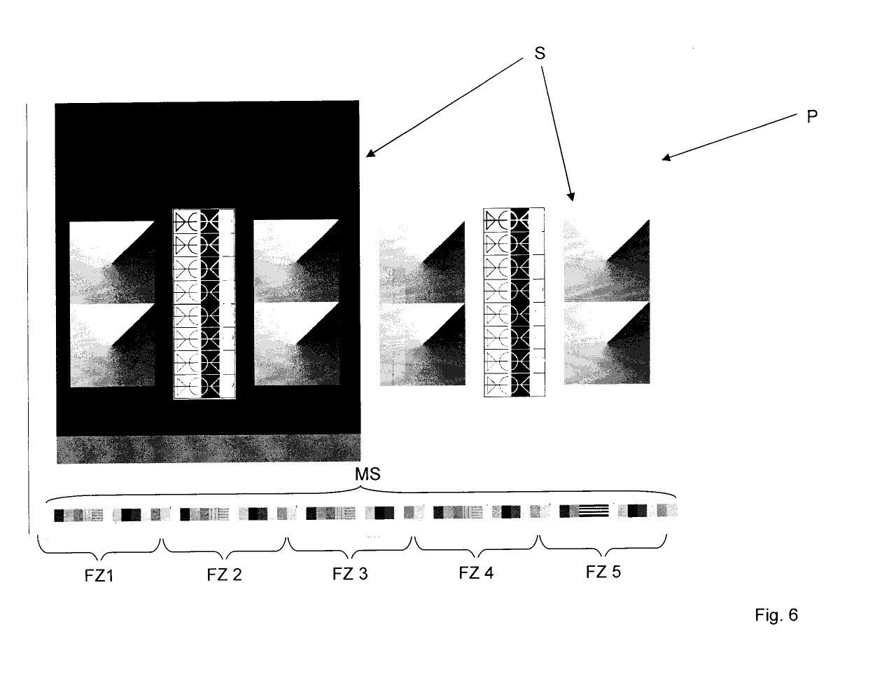

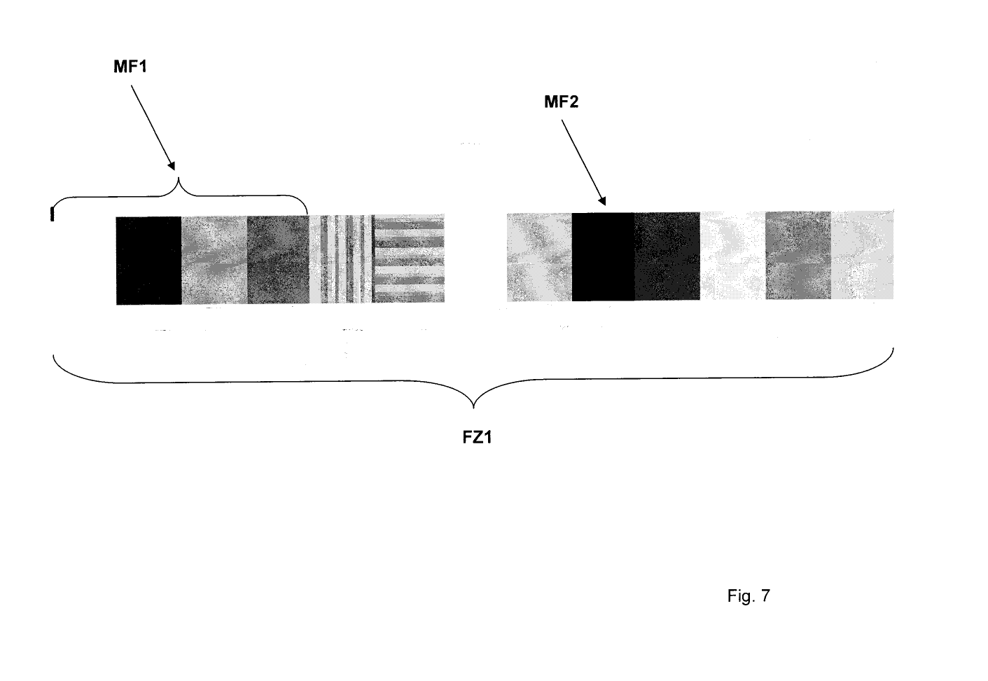

FIG. 6 shows a printed area on a printing substrate P. In this case, a subject S is printed in the form of a graphic image on the printing substrate P. Similarly, a measuring strip MS is printed on the printing substrate P. The measuring strip MS in this case has measuring fields for several ink zones FZ1 to FZ5, which are printed in a distributed manner over the width B of the printing substrate P. These measuring fields are depicted again in an enlarged manner for an ink zone FZ1 in FIG. 7. The measuring fields MF1 are used to determine the tonal value increase via the halftone densities in the regions of 10% to 90% area coverage, i.e., a covering capacity of the ink on the printing substrate of 10% to 90%. The measuring field MF2 is used to determine the full-tone density, i.e., a covering capacity of the ink on the printing substrate with 100% area coverage. However, the aforementioned values for tonal value increase and full-tone density may also be determined from the corresponding regions of the subject S, which correspond to the values for a covering capacity of the ink on the printing substrate of 10% to 90% or for a covering capacity of the ink on the printing substrate with 100% area coverage. These regions may be determined via the ink measuring device 2. However, these regions may be determined by the control and regulating device 3 from the printed image data related to the printed subject S, which may be read out by the control and regulating device 3 as additional preset data V from a memory device or may be conveyed to the control and regulating device 3 by a machine control or may be input to the control and regulating device 3 via a human/machine interface. The control and regulating device 3 may then appropriately trigger the ink measuring device 2 based on these printed image data so that the ink measuring device 2 detects in a targeted manner the appropriate image areas of the subject S, i.e., to determine the tonal value increase, regions of 10% to 90% area coverage, i.e., a covering capacity of the ink on the printing substrate of 10% to 90%, and for determining the full-tone density, regions with a covering capacity of the ink on the printing substrate with 100% area coverage.

FIG. 8 shows an exemplary embodiment of a web-like printing substrate P, for example a paper web, which is printed in an indirect printing method via an offset-printing couple having a plate cylinder PZ, which serves as an impression cylinder 1, and a transfer or rubber cylinder GZ. The reference numbers in FIG. 8 designate analogous devices as those explained on the basis of the previous figures, in particular on the basis of FIG. 1 and FIGS. 6 and 7. The ink measuring devices 2 have an optical detection area. One or more ink measuring devices 2 may be arranged along the width B of the printing substrate P. In this case, subjects S are printed on the printing substrate P at regular intervals. In addition, measuring strips MS may also be printed on the printing substrate P at regular intervals, but these are not absolutely required, because the method described here may also be carried out exclusively based on the subjects S. If measuring strips MS are present, then the method described here may either be carried out exclusively based on the measuring strips MS or based on the measuring strips MS and the subjects S. The ink measuring device 2 may detect the printing parameters of the ink applied to the printing substrate P again selectively (in particular only in the respective optical detection area of one or each respective ink measuring device 2) and/or over the entire width B of the printing substrate P.

In addition, an inking couple 25 (shown only schematically) is provided in FIG. 8 as well as a film dampening unit having a dipping roller 9 and a dampening distribution roller 8. To adjust the quantity of dampening solution, the following adjustments may be made:
the compression of the dipping roller 9 against the dampening distribution roller 8; and/or
the angular adjustment of the dipping roller 9 with respect to the dampening distribution roller 8; and/or
the speed of the dampening distribution roller 8 and/or the dipping roller 9 (i.e., of the dampener fountain roller) by regulating the rotational speed of the drive motor M of the dampening distribution roller 8 or the dipping roller 9.

Thus, the drive motor M in FIG. 8 drives both the dampening distribution roller 8 as well as the dipping roller 9. This may also be realized in that the drive motor M drives the dampening distribution roller 8 either directly and is output from this via a drive coupling, such as a gear, a toothed belt or the like, to the dipping roller 9, or that the drive motor M drives the dipping roller 9 directly and is output from this via a drive coupling, such as a gear, a toothed belt or the like, to the dampening distribution roller 8. However, the motor M may also drive only one of the cited rollers and a separate motor M may be provided for each of the rollers 8, 9.

A control and regulating device 3 is provided in turn for this, which functions in accordance with the control and regulating device 3 already described above, and for this purpose is connected with a data link to the ink measuring device 2. The preset data V for the to-be-regulated settings of the controlled values may be read into the control and regulating device 3; these data may either be saved in a memory device or be input via a human/machine interface.

Similarly, the inking couple 25 is described in terms of regulation with the control and regulating device 3 in an analogous manner as already described above on the basis of the other examples.

### LIST OF REFERENCE NUMBERS

1 Impression cylinder

2 Ink measuring device

3 Control and regulating device

4 Default value (quantity of dampening solution)

5 Regulator

6 Adjusting motors/adjusting devices

7 Form roller

8 Distribution roller

9 Fountain roller/dipping roller

10 Cycle frequency

12 Cycle duration

12 Dampening distribution roller speed

13 Dampening form roller speed

14 Spray bar with nozzles

15 Rotor

16 Shutter

20 Ink duct roller

21 Drive for ink duct roller

22 Ink zone meter

23 Positioning motor for ink zone meter

24 Ink fountain

25 Inking couple

B Width of the printing substrate

FZ Ink zone

GZ Rubber cylinder

IF Actual values of the printing parameters

M Drive motor

MB Measuring area on the printing substrate

MF Measuring field

MS Measuring strip

P Printing substrate

PZ Plate cylinder

S Subject

SF Target values of the printing parameters

V Preset data

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for regulating an application of a dampening solution in a printing press, comprising:
a dampening solution quantity adjustment apparatus, wherein a quantity of dampening solution applyable to a printing press cylinder is adjustable by the dampening solution quantity adjustment apparatus;
an ink measuring device, wherein printing parameters of an ink applied to a printing substrate are detectable by the ink measuring device selectively and/or over an entire width of the printing substrate; and
a control and regulating device, wherein detected printing parameters are analyzable by the control and regulating device and wherein the dampening solution quantity adjustment apparatus is controllable by the control and regulating device.

2. A device for regulating an application of a dampening solution in a printing press, comprising:
a dampening solution quantity adjustment apparatus, wherein a quantity of dampening solution applyable to a printing press cylinder is adjustable by the dampening solution quantity adjustment apparatus;
an ink measuring device, wherein printing parameters of an ink applied to a printing substrate are detectable by the ink measuring device selectively and/or over an entire width of the printing substrate; and
a control and regulating device, wherein a time progression of detected printing parameters is determinable by the control and regulating device and wherein the dampening solution quantity adjustment apparatus is controllable by the control and regulating device.

3. The device according to claim 1 or 2, wherein a full-tone density and/or a tonal value increase of ink applied to the printing substrate is detectable by the ink measuring device.

4. The device according to claim 1 or 2, wherein printing parameters of ink applied in printed measuring strips and/or in printed subjects are detectable by the ink measuring device.

5. The device according to claim 1 or 2, further comprising a second ink measuring device, wherein the ink measuring devices are arranged in a distributed manner over the entire width of the printing substrate.

6. The device according to claim 1 or 2, wherein the ink measuring device is a camera or a spectrometric device.

7. The device according to claim 1 or 2:
further comprising an ink quantity adjustment apparatus, wherein a quantity of ink applyable to the printing press cylinder is adjustable by the ink quantity adjustment apparatus;
wherein actual values of the printing parameters are comparable with predetermined and/or pre-stored target values by the control and regulating device;
and wherein the ink quantity adjustment apparatus is controllable as a function of deviations of the actual values from the predetermined and/or pre-stored target values.

8. The device according to claim 1 or 2:
wherein the dampening solution quantity adjustment apparatus includes a dipping roller and a dampening distribution roller;
and wherein a compressibility of the dipping roller against the dampening distribution roller and/or an angular relationship between the dipping roller with respect to the dampening distribution roller and/or a speed of the dampening distribution roller and/or a speed of the dipping roller, are controllable by the control and regulating device.

9. The device according to claim 1 or 2:
wherein the dampening solution quantity adjustment apparatus is a centrifuge dampening unit having a dampening distribution roller, a dampening form roller, and a shutter;
and wherein the shutter and/or a rotational speed of the dampening distribution roller and/or a rotational speed of the dampening form roller, are controllable by the control and regulating device.

10. The device according to claim 1 or 2:
wherein the dampening solution quantity adjustment apparatus is a spray dampening unit having a dampening distribution roller and a dampening form roller;
wherein a spraying frequency of the spray dampening unit and/or a spraying duration of the spray dampening unit and/or a rotational speed of the dampening distribution roller and/or a rotational speed of the dampening form roller, are controllable by the control and regulating device.

11. The device according to claim 1 or 2, wherein the control and regulating device is a self-learning control and regulating device, wherein a setting of a controlled value is savable in the control and regulating device and is retrievable as preset data.
